(19) United States
(12) Patent Application Publication
(10) Pub. No.: US 2026/0267609 A1
(43) Pub. Date: Sep. 10, 2026

(54) DATA PROCESSING DEVICE

(71) Applicant: NTT, Inc., Tokyo (JP)

(72) Inventors: Saki HATTA, Tokyo (JP); Ken NAKAMURA, Tokyo (JP); Daisuke KOBAYASHI, Tokyo (JP); Hiroyuki UZAWA, Tokyo (JP); Yuya OMORI, Tokyo (JP); Shuhei YOSHIDA, Tokyo (JP); Yuko IINUMA, Tokyo (JP)

(73) Assignee: NTT, Inc., Tokyo (JP)

(21) Appl. No.: 18/875,674

(22) PCT Filed: Jun. 17, 2022
(86) PCT No.: PCT/JP2022/024347

§ 371 Date: Dec. 16, 2024

(51) Int. Cl. G06F 7/544

(52) U.S. Cl. CPC G06F 7/5443

(57) ABSTRACT

There is provided a data processing device 100A including: a multiplication unit 102 that multiplies an input value by a multiplier; an addition unit 104 that adds an output from the multiplication unit 102 and a polynomial coefficient and outputs an addition result; a holding unit 106 that holds an output from the addition unit 104; and a selection unit 101 that selects and outputs the multiplier in the multiplication unit 102 from among data held in the holding unit 106 and polynomial coefficients to be output to the multiplication unit 102.

### TECHNICAL FIELD

The disclosed technique relates to a data processing device.

### BACKGROUND ART

An activation function in a neural network of artificial intelligence (AI) is a function that converts any input value into another numerical value and outputs the converted value when outputting a value from a certain neuron to the next neuron. There are a plurality of types of activation functions such as a sigmoid function, a tanh function, and a ReLU, and the functions to be used are different depending on AI models to be handled. In recent years, You Only Look Once (YOLO) which is an object detection model based on AI (Non Patent Literature 1), an attitude estimation model OpenPose (Non Patent Literature 2), and the like have been disclosed. In addition, attention is focused on edge AI for mounting these models on a small device such as a drone or a monitoring camera.

In a case where inference processing of a plurality of AI models is realized by a device with limited resources to be mounted on the edge AI, it is necessary to prepare a circuit for each type of the activation function corresponding to each model, and as a result, hardware resources are increased. In addition, only a circuit for a function which is determined at a time of design can be prepared, and as a result, there is a problem that extensibility to the future is lacking.

In order to solve such a problem, as a method of realizing a plurality of types of activation function processing with low resources, there is a method of expressing an activation function by a piecewise polynomial approximation. The piecewise polynomial approximation is a method of dividing an input domain into equal intervals and approximating an output y in the interval by an nth-order polynomial. For example, Non Patent Literature 3 discloses a configuration for realizing a piecewise polynomial.

FIG. 7 is a diagram illustrating a configuration for realizing a piecewise polynomial disclosed in Non Patent Literature 3. A coefficient is selected by a selector 1001A, and a multiplication unit 1002A multiplies an input x by the coefficient selected by the selector 1001A. Further, a coefficient is selected by a selector 1003A, and an output of the multiplication unit 1002A and the coefficient selected by the selector 1003A are added by an addition unit 1004A.

In addition, the input x is held by a holding unit 1005A, and the input x and an output of the addition unit 1004A are multiplied by a multiplication unit 1002B. Further, a coefficient is selected by a selector 1003B, and an output of the multiplication unit 1002B and the coefficient selected by the selector 1003B are added by an addition unit 1004B.

According to this configuration, an output y with respect to the input x can be expressed by a polynomial of the following expression (1), and thus it is possible to implement a multiplier and an adder with a simple configuration. Thereby, it is possible to reduce hardware resources. In addition, the coefficients are stored in a memory. Thus, by rewriting the memory, it is possible to correspond to a plurality of types of activation functions.

$$y = {C}_{n} {x}^{n} + {C}_{n - 1} {x}^{n - 1} + … + {C}_{1} x + {C}_{0} \qquad ( 1 )$$

### CITATION LIST

### Non Patent Literature

Non Patent Literature 1: Joseph Redmon et. al, “YOLOv3: An Incremental Improvement”, the Internet <URL: https://arxiv.org/abs/1804.02767>
Non Patent Literature 2: Zhe Cao et. al, “Realtime Multi-Person 2D Pose Estimation using Part Affinity Fields”, the Internet <URL: https://arxiv.org/pdf/1611.08050.pdf>
Non Patent Literature 3: Shinobu Nagayama et al., “Numerical Function Generators Based on Polynomial Approximation Suitable for FPGA Implementation”, Technical Report of IEICE

### SUMMARY OF INVENTION

### Technical Problem

However, in the configuration in the related art, a circuit does not need to be prepared for each type of the activation function, but there is a problem that the number of sets of the holding unit, the multiplication unit, the addition unit, and the selector increases in proportion to the order n of the polynomial corresponding to the activation function and a circuit scale increases. In addition, as n increases, the number of bits in a multiplication result increases according to the increase. As a result, a bit width of the addition unit in a subsequent stage also increases. That is, the circuit scale of the configuration corresponding to the nth-order polynomial approximation increases due to an increase in both the number of sets of the holding unit, the multiplication unit, the addition unit, and the selector and the bit width of each calculator. An increase in the circuit scale is a fatal problem in a device for edge AI.

The disclosed technique has been made in view of the above points, and an object of the disclosed technique is to provide a data processing device in which a circuit scale of a circuit that performs numerical calculation based on polynomial approximation is reduced as compared with the configuration in the related art.

### Solution to Problem

According to a first aspect of the present disclosure, there is provided a data processing device including: a multiplication unit that multiplies an input value by a multiplier; an addition unit that adds an output from the multiplication unit and a polynomial coefficient and outputs an addition result; a holding unit that holds an output from the addition unit; and a selection unit that selects and outputs the multiplier in the multiplication unit from among data held in the holding unit and polynomial coefficients to be output to the multiplication unit.

### Advantageous Effects of Invention

According to the disclosed technique, even in a case where the number of types of activation functions that can be processed or the order of polynomial approximation is increased, the circuit scale does not increase. Therefore, it is possible to provide a data processing device in which the circuit scale of a circuit that performs a numerical calculation based on polynomial approximation is reduced as compared with the configuration in the related art.

### BRIEF DESCRIPTION OF DRAWINGS

FIG. 1 is a diagram illustrating a configuration of a data processing device according to a first embodiment.

FIG. 2 is a flowchart illustrating a flow of polynomial approximation processing by the data processing device.

FIG. 3 is a diagram illustrating a configuration of a data processing device according to a second embodiment.

FIG. 4 is a flowchart illustrating a flow of polynomial approximation processing by the data processing device.

FIG. 5 is a diagram illustrating a configuration of a data processing device according to a third embodiment.

FIG. 6 is a flowchart illustrating a flow of polynomial approximation processing by the data processing device.

FIG. 7 is a diagram illustrating a configuration of a data processing device in the related art.

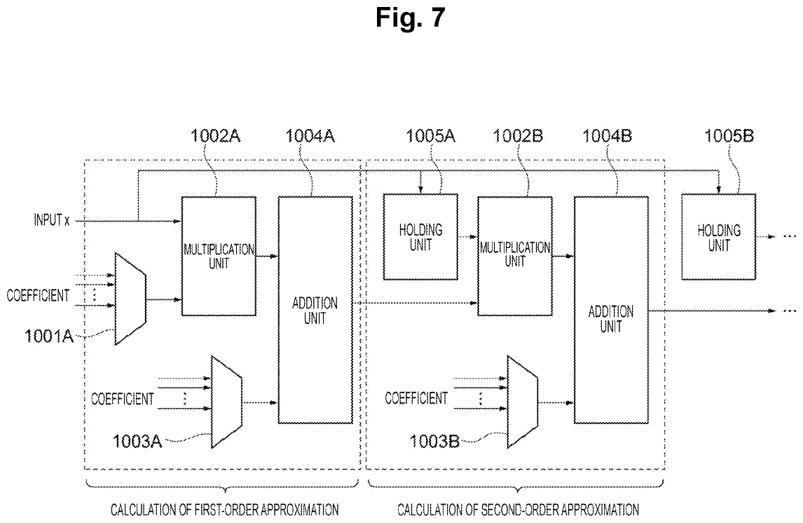

### DESCRIPTION OF EMBODIMENTS

Hereinafter, an example of an embodiment of the disclosed technique will be described with reference to the drawings. In the drawings, the same or equivalent components and portions are denoted by the same reference numerals. Further, dimensional ratios in the drawings are exaggerated for convenience of description, and may be different from actual ratios.

### First Embodiment

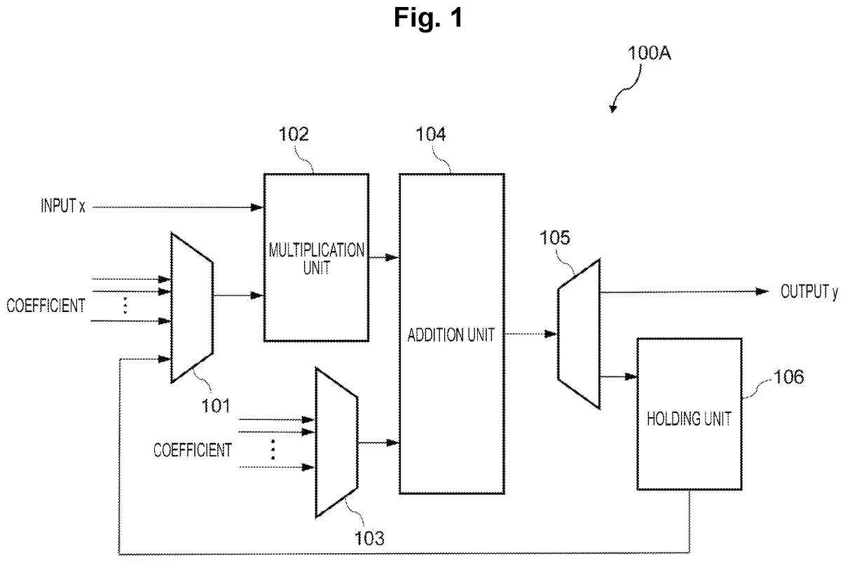

FIG. 1 is a diagram illustrating a configuration of a data processing device according to a first embodiment. The data processing device 100A illustrated in FIG. 1 includes a first selector 101, a multiplication unit 102, a second selector 103, an addition unit 104, a switch 105, and a holding unit 106.

The first selector 101 is an example of a selection unit of the present disclosure, and selects a coefficient by which the input x is multiplied by the multiplication unit 102 or a value held in the holding unit 106, and outputs the selected value to the multiplication unit 102. In a case where the data processing device 100A performs a calculation of a first-order polynomial, the first selector 101 selects a coefficient to be multiplied by the input x by the multiplication unit 102. In a case where the data processing device 100A performs a calculation of an nth-order polynomial which is a second-order or higher-order polynomial, the first selector 101 selects the value held in the holding unit 106 when the nth-order calculation is not completed.

The multiplication unit 102 is configured with a multiplier capable of processing a predetermined number of bits, multiplies an input x which is input to the data processing device 100A and serves as a multiplier by an output from the first selector 101 which serves as a multiplicand, and outputs the multiplication result.

The second selector 103 selects a polynomial coefficient to be added to the output from the multiplication unit 102 by the addition unit 104, and outputs the polynomial coefficient to the addition unit 104.

The addition unit 104 is configured with an adder capable of processing a predetermined number of bits, adds the output of the multiplication processing from the multiplication unit 102 and the coefficient which is output from the second selector 103, and outputs the addition result.

The switch 105 performs switching as to whether to output the output of the addition processing by the addition unit 104 as an output y or to output the output of the addition processing to the holding unit 106. In a case where the data processing device 100A performs a calculation of a first-order polynomial, the switch 105 performs switching to output the output of the addition processing by the addition unit 104 as the output y. In addition, in a case where the data processing device 100A performs a calculation of an nth-order polynomial which is a second-order or higher-order polynomial, the switch 105 performs switching to output the output of the addition processing by the addition unit 104 as an output y when the nth-order calculation is completed, and performs switching to output the output of the addition processing by the addition unit 104 to the holding unit 106 when the nth-order calculation is not completed. In the present embodiment, a switch is used to perform switching as to whether to output the output of the addition processing by the addition unit 104 as an output y or to output the output of the addition processing to the holding unit 106. On the other hand, the present disclosure is not limited to such an example. A demultiplexer may be used to perform switching as to whether to output the output of the addition processing by the addition unit 104 as an output y or to output the output of the addition processing to the holding unit 106. In a case where a demultiplexer is used, an output destination of the demultiplexer controls whether or not to adopt the output value as an output.

The holding unit 106 is a buffer for matching input timings, and holds the output of the addition processing by the addition unit 104. In a case where the calculation of the nth-order polynomial is performed, the value held in the holding unit 106 is output to the multiplication unit 102 when the nth-order calculation is not completed, the nth-order polynomial being a second-order or higher-order polynomial. That is, in a case where the data processing device 100A performs a calculation of a second-order polynomial, when only the first-order calculation is completed, content held in the holding unit 106 is output to the multiplication unit 102 by the first selector 101.

By providing the holding unit 106, the data processing device 100A can perform a calculation of the nth-order polynomial approximation by repeating the calculation by one set of the multiplication unit 102, the addition unit 104, the first selector 101, and the second selector 103 a plurality of times. Each of coefficients transmitted to the multiplication unit 102 and the addition unit 104 is stored in, for example, a memory or a register, and the storage location is not defined in the present embodiment. The coefficients have different values for each of types of the activation functions and for each input domain. By rewriting these values, the data processing device 100A can realize polynomial approximation processing of a plurality of types of the activation functions.

Next, an operation of the data processing device 100A will be described.

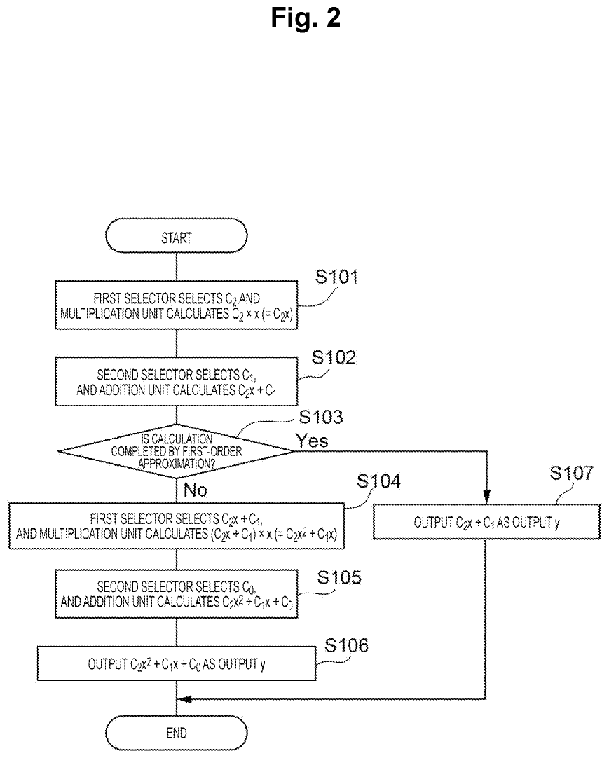

FIG. 2 is a flowchart illustrating a flow of polynomial approximation processing by the data processing device 100A. FIG. 2 illustrates polynomial approximation processing of a second-order polynomial (output y=C₂x²+C₁x+C₀) when n=2.

In the data processing device 100A, first, the first selector 101 selects the coefficient C₂, and the multiplication unit 102 calculates C₂×x (step S101).

Subsequent to step S101, in the data processing device 100A, the second selector 103 selects the coefficient C₁, and the addition unit 104 calculates C₂x+C₁ (step S102).

Subsequent to step S102, the data processing device 100A determines whether or not the calculation is completed by the first-order approximation (step S103).

As a result of the determination in step S103, in a case where the calculation is not completed by the first-order approximation (No in step S103), in the data processing device 100A, the first selector 101 selects C₂x+C₁ that is an addition result of the addition unit 104 in step S102, and the multiplication unit 102 calculates (C₂x+C₁)×x (step S104).

Subsequent to step S104, in the data processing device 100A, the second selector 103 selects the coefficient C₀, and the addition unit 104 calculates C₂x²+C₁x+C₀ (step S105).

Subsequent to step S105, the data processing device 100A outputs C₂x²+C₁x+C₀ as an output y (step S106).

On the other hand, as a result of the determination in step S103, in a case where the calculation is completed by the first-order approximation (Yes in step S103), the data processing device 100A outputs C₂x+C₁ as an output y (step S107).

Although an example of the second-order approximation polynomial is illustrated in the flowchart illustrated in FIG. 2, the data processing device 100A can perform a calculation of a third-order or higher-order approximation polynomial by repeating the processing of step S103 to step S106 a plurality of times. At this time, the data processing device 100A selects whether to output the output from the addition unit 104 as an output y or to output the output from the addition unit 104 to the holding unit 106 each time by switching the switch 105.

As described above, the data processing device 100A can perform a calculation of the nth-order polynomial approximation by repeating the calculation by one set of the multiplication unit 102, the addition unit 104, the first selector 101, and the second selector 103 a plurality of times.

### Second Embodiment

In the first embodiment, even in the case of the nth-order approximation polynomial, the example in which the circuit scale is reduced by a method of performing processing by sharing the multiplication unit, the addition unit, and the selector has been described. In the second embodiment, a configuration and a processing method for reducing the circuit scales of the multiplication unit and the addition unit by reducing the number of bits handled by the multiplication unit and the addition unit will be described.

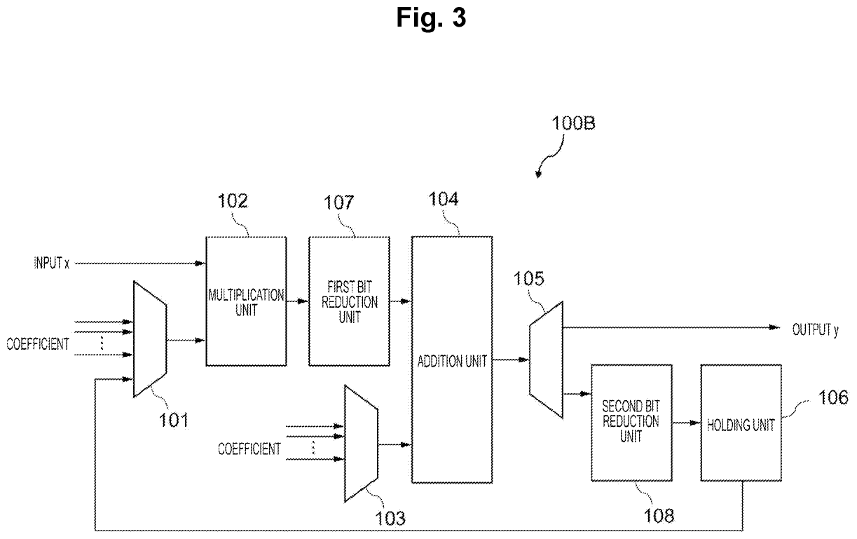

FIG. 3 is a diagram illustrating a configuration of a data processing device according to a second embodiment. The data processing device 100B illustrated in FIG. 3 includes a first selector 101, a multiplication unit 102, a second selector 103, an addition unit 104, a switch 105, a holding unit 106, a first bit reduction unit 107, and a second bit reduction unit 108. In the following description, the first bit reduction unit 107 and the second bit reduction unit 108, which are components added from the configuration of the first embodiment, will be described in detail.

The first bit reduction unit 107 is provided at a subsequent stage of the multiplication unit 102, and reduces the number of bits of the output data from the multiplication unit 102 to the number of bits that can be calculated by the addition unit 104. For example, in a case where the multiplication unit 102 is configured with a k-bit multiplier and the addition unit 104 is configured with an l-bit adder, the first bit reduction unit 107 reduces the bit width of the output data from the multiplication unit 102 to l bits.

The second bit reduction unit 108 is provided at a subsequent stage of the switch 105, and reduces the number of bits of the output data from the addition unit 104 to the number of bits that can be calculated by the multiplication unit 102. For example, in a case where the multiplication unit 102 is configured with a k-bit multiplier and the addition unit 104 is configured with an l-bit adder, the second bit reduction unit 108 reduces the bit width of the output data from the addition unit 104 to k bits.

The first bit reduction unit 107 and the second bit reduction unit 108 perform rounding processing or truncating processing by removing bits from a least significant bit side of the output data so as to match the bit width of the multiplication unit 102 or the addition unit 104 in the subsequent stage.

Since the data processing device 100B includes the first bit reduction unit 107 and the second bit reduction unit 108, the circuit scales of the multiplier in the multiplication unit 102 and the adder in the addition unit 104 can be reduced. Since the data processing device 100B includes the first bit reduction unit 107 and the second bit reduction unit 108, a size of the entire device can also be reduced. In a case where the first bit reduction unit 107 and the second bit reduction unit 108 are newly added, the circuit scales of the corresponding portions are increased. On the other hand, as compared with the multiplier and the adder corresponding to the nth-order approximation polynomial, the circuit scales of the first bit reduction unit 107 and the second bit reduction unit 108 are reduced. In particular, as the corresponding n increases, the scales of the multiplier and the adder increase. Thus, an effect according to the present embodiment is increased.

In the present embodiment, the configuration in which the output y is output without performing bit reduction of a data length has been described, but the present disclosure is not limited to such an example. For example, the second bit reduction unit 108 may be provided in a preceding stage of the switch 105, and data with a shortened data length may be output as the output y.

In the AI inference model, the output value after activation function processing is performed is an input value of the next layer. For this reason, it is necessary to reduce an increase in the bit width by the nth-order polynomial calculation before the output value is input to the next layer. In the present embodiment, the bits are reduced during the activation function processing in view of the processing characteristics of the AI inference model. Thus, it is possible to prevent accuracy deterioration due to bit reduction.

Next, an operation of the data processing device 100B will be described.

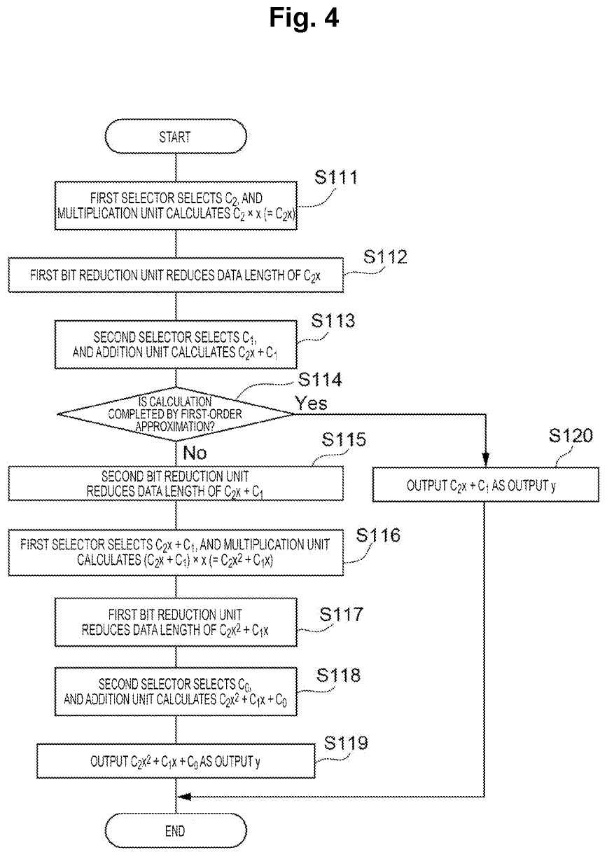

FIG. 4 is a flowchart illustrating a flow of polynomial approximation processing by the data processing device 100B. FIG. 4 illustrates polynomial approximation processing of a second-order polynomial (output y=C₂x²+C₁x+C₀) when n=2.

In the data processing device 100B, first, the first selector 101 selects the coefficient C₂, and the multiplication unit 102 calculates C₂×x (step S111).

Subsequent to step S111, in the data processing device 100B, the first bit reduction unit 107 reduces the data length of C₂×x (step S112).

Subsequent to step S112, in the data processing device 100B, the second selector 103 selects the coefficient C₁, and the addition unit 104 calculates C₂x+C₁ (step S113).

Subsequent to step S113, the data processing device 100B determines whether or not the calculation is completed by the first-order approximation (step S114).

As a result of the determination in step S114, in a case where the calculation is not completed by the first-order approximation (No in step S114), in the data processing device 100B, the second bit reduction unit 108 reduces the data length of C₂x+C₁ (step S115).

Subsequent to step S115, in the data processing device 100B, the first selector 101 selects C₂x+C₁ that is an addition result of the addition unit 104 in step S113, and the multiplication unit 102 calculates (C₂x+C₁)×x (step S116).

Subsequent to step S116, in the data processing device 100B, the first bit reduction unit 107 reduces the data length of (C₂x+C₁)×x=C₂x²+C₁x (step S117).

Subsequent to step S117, in the data processing device 100B, the second selector 103 selects the coefficient C₀, and the addition unit 104 calculates C₂x²+C₁x+C₀ (step S118).

Subsequent to step S118, the data processing device 100B outputs C₂x²+C₁x+C₀ as an output y (step S119).

On the other hand, as a result of the determination in step S114, in a case where the calculation is completed by the first-order approximation (Yes in step S114), the data processing device 100B outputs C₂x+C₁ as an output y (step S120).

Although the processing flow of FIG. 4 illustrates a flow in which the multiplication unit multiplies the input x and the coefficient C₂ in one step, the present disclosure is not limited to such an example. For example, the data processing device 100B may perform a calculation of C₂x in multiple steps. The data processing device 100B can further reduce the multiplier of the multiplication unit 102 by performing the calculation of C₂x in multiple steps. Thus, it is possible to further reduce the scale of the entire device. The calculation performed in multiple steps may be applied to at least one or both of the multiplication unit 102 and the addition unit 104.

### Third Embodiment

In the second embodiment, the configuration and the processing method for reducing the circuit scales of the multiplication unit and the addition unit by reducing the number of bits handled by the multiplication unit and the addition unit have been described. In the third embodiment, in addition to the second embodiment, a configuration and a processing method for shortening an input data length of the multiplication unit 102 and reducing a data bit width handled by the multiplication unit 102 by converting the input x into Δx will be described.

Specifically, the input is converted into the number of inputs with a section width obtained by dividing the input domain into equal sections. For example, in a case where the data width of the original input x is 8 bits and the number of sections for the domain of the input x is 64 sections, the number of inputs with a section width is 2⁸/64=4. In this case, it is sufficient that data corresponding to four inputs can be expressed. Thus, the input data after the conversion may have two bits. Using these 2 bits, Δx obtained by converting the input x is expressed as −2, −1, 0, and 1. Each coefficient in the polynomial is calculated in advance using Δx, and is stored so as to be selected by the selector.

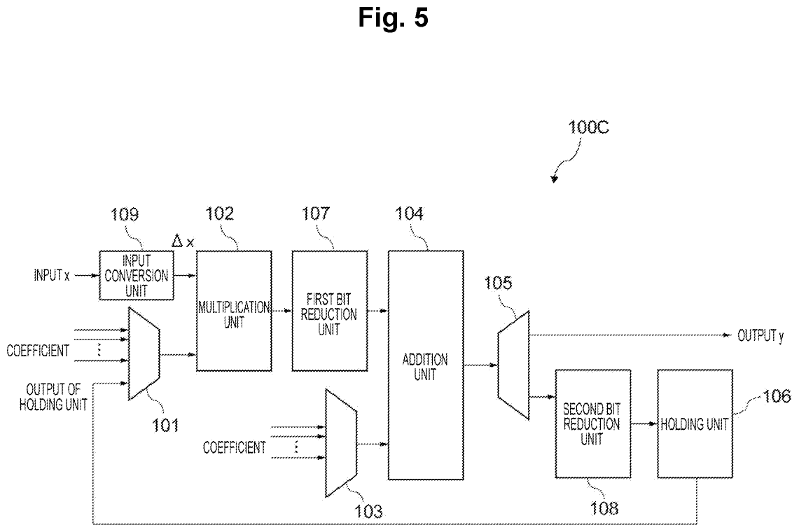

FIG. 5 is a diagram illustrating a configuration of a data processing device according to a third embodiment. The data processing device 100C illustrated in FIG. 5 includes a first selector 101, a multiplication unit 102, a second selector 103, an addition unit 104, a switch 105, a holding unit 106, a first bit reduction unit 107, a second bit reduction unit 108, and an input conversion unit 109. In the following description, the input conversion unit 109, which is a component added from the configuration of the second embodiment, will be described in detail.

The input conversion unit 109 performs predetermined conversion processing on the input x and outputs Δx. Specifically, the input conversion unit 109 performs conversion processing of compressing the number of bits of the input x by a predetermined compression method, and outputs Δx.

The conversion processing in the input conversion unit 109 will be described in a generalized manner. Assuming that the data length of the input x is d bits and the number of sections is N sections, the input is converted into Δx by the following 2's complement representation.

$$Δ x = - ( {2}^{d} / N ) / 2 ∼ + ( ( {2}^{d} / N ) / 2 - 1 )$$

The bit width of Δx is log₂(2^{d}/N), and the bit width that can be reduced is d-log₂(2^{d}/N) bits. Assuming that the number of the sections N is a value (N=2^{m}) that can be expressed by a power of 2, the bit width that can be reduced is represented by the following expression.

$$d - {log}_{2} ( {2}^{d} / N ) = d - {log}_{2} ( {2}^{d} / {2}^{m} ) = d - {log}_{2} {2}^{( d - m )} = d - ( d - m ) = m$$

That is, by providing the input conversion unit 109, the number of bits of the input x is compressed. Thus, the multiplication unit 102 can be reduced by the m-bit width.

In the data processing device 100C, by providing the input conversion unit 109 that converts the input x into Δx, the circuit scale of the multiplier of the multiplication unit 102 is reduced, and the circuit scale of the adder of the addition unit 104 in the subsequent stage is also reduced. Thereby, the size of the entire data processing device 100C can be further reduced as compared with the data processing devices 100A and 100B.

Next, an operation of the data processing device 100C will be described.

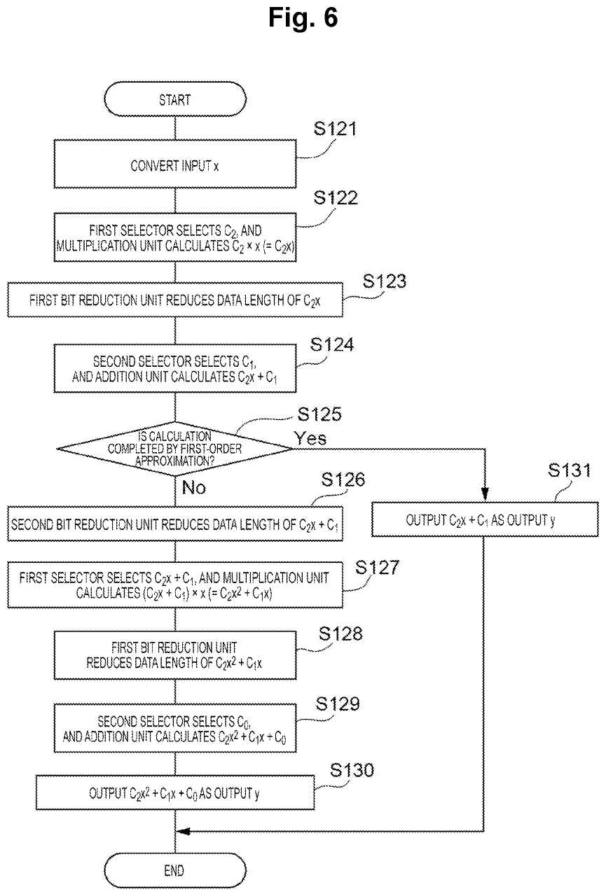

FIG. 6 is a flowchart illustrating a flow of polynomial approximation processing by the data processing device 100C. FIG. 6 illustrates polynomial approximation processing of a second-order polynomial (output y=C₂x²+C₁x+C₀) when n=2.

First, in the data processing device 100C, the input conversion unit 109 converts the input x into Δx and outputs Δx (step S121).

Subsequent to step S121, in the data processing device 100C, the first selector 101 selects the coefficient C₂, and the multiplication unit 102 calculates C₂×x (step S122).

Subsequent to step S122, in the data processing device 100C, the first bit reduction unit 107 reduces the data length of C₂×x (step S123).

Subsequent to step S123, in the data processing device 100C, the second selector 103 selects the coefficient C₁, and the addition unit 104 calculates C₂x+C₁ (step S124).

Subsequent to step S124, the data processing device 100C determines whether or not the calculation is completed by the first-order approximation (step S125).

As a result of the determination in step S125, in a case where the calculation is not completed by the first-order approximation (No in step S125), in the data processing device 100C, the second bit reduction unit 108 reduces the data length of C₂x+C₁ (step S126).

Subsequent to step S126, in the data processing device 100C, the first selector 101 selects C₂x+C₁ that is an addition result of the addition unit 104 in step S124, and the multiplication unit 102 calculates (C₂x+C₁)×x (step S127).

Subsequent to step S127, in the data processing device 100C, the first bit reduction unit 107 reduces the data length of (C₂x+C₁)×x=C₂x²+C₁x (step S128).

Subsequent to step S128, in the data processing device 100C, the second selector 103 selects the coefficient C₀, and the addition unit 104 calculates C₂x²+C₁x+C₀ (step S129).

Subsequent to step S129, the data processing device 100C outputs C₂x²+C₁x+C₀ as an output y (step S130).

On the other hand, as a result of the determination in step S125, in a case where the calculation is completed by the first-order approximation (Yes in step S125), the data processing device 100C outputs C₂x+C₁ as an output y (step S131).

Although the processing flow of FIG. 6 illustrates a flow in which the multiplication unit multiplies the input x and the coefficient C₂ in one step, the present disclosure is not limited to such an example. For example, the data processing device 100C may calculate C₂x in multiple steps. The data processing device 100C can further reduce the multiplier of the multiplication unit 102 by calculating C₂x in multiple steps. Thus, it is possible to further reduce the scale of the entire device. The calculation performed in multiple steps may be applied to the addition unit 104.

In the third embodiment, the first bit reduction unit 107, the second bit reduction unit 108, and the input conversion unit 109 are all included, but the present disclosure is not limited to such an example. At least one of the first bit reduction unit 107, the second bit reduction unit 108, and the input conversion unit 109 may be provided.

### REFERENCE SIGNS LIST

100A, 100B, 100C Data processing device
101 First selector
102 Multiplication unit
103 Second selector
104 Addition unit
105 Switch
106 Holding unit
107 First bit reduction unit
108 Second bit reduction unit
109 Input conversion unit

1. A data processing device comprising:
a memory; and
at least one processor connected to the memory,
wherein the processor is configured to:
multiply an input value by a multiplier using a multiplier unit;
add an output from the multiplier unit and a polynomial coefficient using an adder and output an addition result;
hold an output from the adder in the memory; and
select and output the multiplier in the multiplier unit from among data held in the memory and polynomial coefficients to be output to the multiplier unit.

2. The data processing device according to claim 1, wherein the processor is configured to select content held in the memory as the multiplier in a case where a calculation of a second-order or higher-order polynomial is performed.

3. The data processing device according to claim 1, wherein the processor is configured to reduce a data length of data which is output from the multiplier unit and outputs the data to the adder.

4. The data processing device according to of claim 1, wherein the processor is configured to reduce a data length of data which is output from the adder and outputs the data.

5. The data processing device according to claim 4, wherein the processor is configured to convert the input value by a predetermined compression method and outputs the converted input value to the multiplier unit.

6. The data processing device according to claim 5, wherein the processor is configured to convert the input value into a value determined by a data length of the input value and the number of sections in piecewise polynomial approximation.

7. The data processing device according to claim 5, wherein calculation of either or both of the multiplier unit and the adder is repeatedly performed a plurality of times.

8. The data processing device according to claim 1, wherein calculation of either or both of the multiplier unit and the adder is repeatedly performed a plurality of times.
